(19) United States
(12) Patent Application Publication
(10) Pub. No.: US 2018/0061259 A1
(43) Pub. Date: Mar. 1, 2018

(54) CORRELATING MEMBERS WITH CLUSTERS OF ONLINE COURSE CONTENT

(71) Applicant: Linkedln Corporation, Sunnyvale, CA (US)

(72) Inventors: Ming Ng, Santa Barbara, CA (US); Sandeep Rohilla, Belmont, CA (US)

(21) Appl. No.: 15/253,718

(22) Filed: Aug. 31, 2016

(51) Int. Cl. G09B 5/12; G09B 7/00

(52) U.S. Cl. CPC G09B 5/12; G09B 7/00

(57) ABSTRACT

System and methods for correlating members with clusters of online course content are disclosed. A server system accessing a plurality of course records associated with a plurality of courses from a database. The server system identifies, for each particular course in the plurality of courses, a list of members of the server system that have accessed content associated with the particular course. The server system applies a clustering algorithm to each course to create a third group of courses. The server system determines member demand for courses included in the third group of courses. In accordance with a determination that the member demand for courses in included in the third group of courses is equal to or greater than a member demand threshold, the server system transmits a request for additional course content to a content provider.

### TECHNICAL FIELD

The disclosed example embodiments relate generally to the field of online-based education and, in particular, to grouping videos by member activity.

### BACKGROUND

The rise of the computer age has resulted in increased access to personalized services online. As the cost of electronics and networking services drops, many services can be provided remotely over the Internet. For example, entertainment has increasingly shifted to the online space with companies such as Netflix and Amazon streaming television shows and movies to members at home. Similarly, electronic mail (email) has reduced the need for letters to be physically delivered. Instead, messages are sent over networked systems almost instantly.

Another service that can be provided over computer networks is a network-based educational service. Such services provide materials (e.g., videos, text, interactive materials, and audio materials) that allow members to learn a skill or about a particular topic. Said educational services can be associated with a traditional educational institution, a commercial educational institutional, or operate independently.

In some example embodiments, an online educational service has a plurality of courses, each of which includes a plurality of educational materials. Furthermore, the service has a structure for organizing each course (e.g., a category system) based on the expected use of the course by members of the online educational service.

### DESCRIPTION OF THE DRAWINGS

Some example embodiments are illustrated by way of example and not limitation in the figures of the accompanying drawings.

FIG. 1 is a network diagram depicting a client-server system that includes various functional components of a server system, in accordance with some example embodiments.

FIG. 2 is a block diagram illustrating a client system, in accordance with some example embodiments.

FIG. 3 is a block diagram illustrating a server system, in accordance with some example embodiments.

FIG. 4 is a block diagram of an exemplary data structure for member profile data, in accordance with some example embodiments.

FIG. 5 is a user interface diagram illustrating an example of a user interface or web page that incorporates one or more course recommendations for courses available at a server system.

FIG. 6 is a flow diagram illustrating a method, in accordance with some example embodiments, for grouping members and courses based on member course access records.

FIG. 7 is a flow diagram illustrating a method, in accordance with some example embodiments, for grouping courses in a multi-course educational system at a server system.

FIGS. 8A-8C are flow diagrams illustrating a method, in accordance with some example embodiments, for grouping courses in a multi-course educational system at a server system.

FIG. 9 is a block diagram illustrating an architecture of software, which may be installed on any of one or more devices, in accordance with some example embodiments.

FIG. 10 is a block diagram illustrating components of a machine, according to some example embodiments.

Like reference numerals refer to corresponding parts throughout the drawings.

### DETAILED DESCRIPTION

The present disclosure describes methods, systems, and computer program products for determining member quality for members of a server system. In the following description, for purposes of explanation, numerous specific details are set forth to provide a thorough understanding of the various aspects of different example embodiments. It will be evident, however, to one skilled in the art, that any particular example embodiment may be practiced without all of the specific details and/or with variations, permutations, and combinations of the various features and elements described herein.

In some example embodiments, an online education system offers a plurality of courses to its members. Each course includes a plurality of lessons, each of which is associated with at least one piece of educational material. Educational materials include text-based materials (e.g., books, webpages, and so on), videos, audio materials, interactive materials, quizzes, tests, and so on.

The online education system organizes the courses based on subject titles. In some example embodiments, the online educational system has a course organization structure (e.g., a series of subjects in a hierarchy) and each new course is added to the course organization structure manually when the course is added. However, manually organizing courses based on titles, subjects, or intended use does not reflect the actual use patterns by members of the online educational system.

In some example embodiments, each time a member accesses (e.g., views) an educational material, the online educational system records the member, the piece of educational material, and the time of the access. In this way, the online educational system maintains a database of a plurality of instances of a member viewing a piece of educational material.

In some example embodiments, the online educational system performs a clustering algorithm on members of the online educational system based on their history of accessing educational materials through the online educational system, such that members who view similar educational content are grouped into similar interest groups. In this way, members who have a history of watching similar educational materials are grouped together. In this way, the members are grouped based on their actions, rather than predetermined content grouping.

Similarly, the courses themselves can be put into interest groups based on the viewing habits of the members. For example, if a particular type of member is an IT professional that works with Linux systems, then videos commonly watched by that type of member can be placed in the group “Linux IT professional,” regardless of whether they were grouped in the more traditional course grouping system. Thus, if a particular database management course is frequently viewed by Linux IT professionals, but not by database management professionals, the course will be grouped with the Linux IT professional courses rather than the database management courses.

In some example embodiments, the online educational system determines that each member interest group has different quantifiable characteristics with respect to total expected revenue, length of membership, member interaction with the online educational system, and so on. In some example embodiments, the online educational system determines which member interest group results in the most value generated for the online educational system and can recommend additional resources (e.g., new courses and advertising) for those members.

In some example embodiments, when a new member joins the online educational system, the online educational system uses the member's activity to determine which member interest group the member is most closely associated with. In some example embodiments, the online educational system generates recommendations based on the determined member interest group.

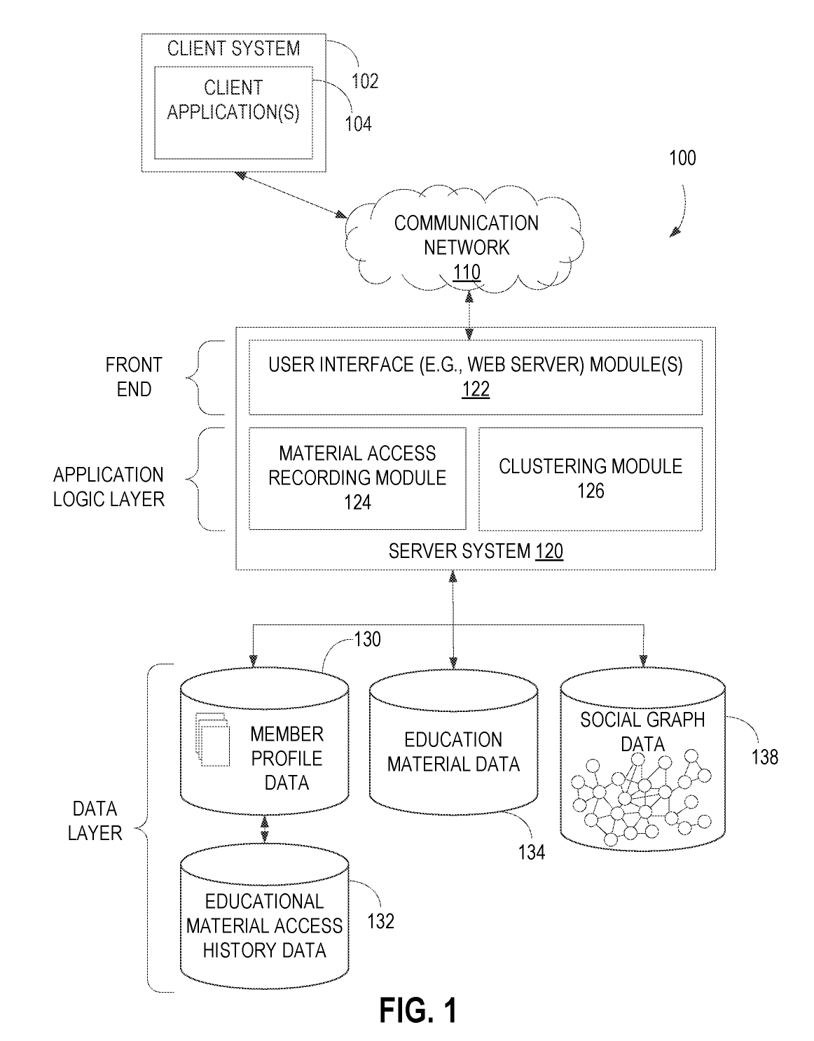

FIG. 1 is a network diagram depicting a client-server system environment 100 that includes various functional components of a server system 120, in accordance with some example embodiments. The client-server system environment 100 includes one or more client systems 102 and the server system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, the client system 102 is an electronic device, such as a personal computer (PC), a laptop, a smartphone, a tablet, a mobile phone, or any other electronic device capable of communication with the communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses a web browser to send and receive requests to and from the server system 120 and to display information received from the server system 120.

In some example embodiments, the client system 102 includes an application specifically customized for communication with the server system 120 (e.g., a LinkedIn iPhone application). In some example embodiments, the server system 120 is a server system that is associated with one or more services.

In some example embodiments, the client system 102 sends a request to the server system 120 for a webpage associated with the server system 120. For example, a member uses the client system 102 to log into the server system 120 and request a particular piece of educational material associated with a particular educational course (e.g., a set of educational materials intended to educate a member on a certain topic). In response, the client system 102 receives the requested piece of educational material and displays that piece of educational material in a user interface on the client system 102.

In some example embodiments, as shown in FIG. 1, the server system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary. detail, various functional modules and engines that are not germane to conveying an understanding of the various example embodiments have been omitted from FIG. 1. However, a skilled artisan will readily recognize that various additional functional modules and engines may be used with a server system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although the server system 120 is depicted in FIG. 1 as having a three-tiered architecture, the various example embodiments are by no means limited to this architecture.

As shown in FIG. 1, the front end consists of a user interface module (e.g., a web server) 122, which receives requests from various client systems 102 and communicates appropriate responses to the requesting client systems 102. For example, the user interface module(s) 122 may receive requests in the form of Hypertext Transfer Protocol (HTTP) requests, or other web-based, application programming interface (API) requests. The client system 102 may be executing conventional web browser applications or applications that have been developed for a specific platform to include any of a wide variety of mobile devices and operating systems.

As shown in FIG. 1, the data layer includes several databases, including databases for storing data for various members of the server system 120, including member profile data 130, educational material access history data 132, education material data 134, and social graph data 138, which is data stored in a particular type of database that uses graph structures with nodes, edges, and properties to represent and store data. Of course, in various alternative example embodiments, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with other entities.

Consistent with some example embodiments, when a person initially registers to become a member of the server system 120, the person will be prompted to provide some personal information, such as his or her name, age (e.g., birth date), gender, contact information, home town, address, educational background (e.g., schools, majors, etc.), current job title, job description, industry, employment history, skills, professional organizations, memberships with other online service systems, and so on. This information is stored, for example, in the member profile data 130.

In some example embodiments, the member profile data 130 includes or is associated with the member interaction data. In other example embodiments, the member interaction data is distinct from, but associated with, the member profile data 130. The member interaction data stores data detailing the various interactions each member has through the server system 120. In some example embodiments, interactions include posts, likes, messages, adding or removing social contacts, and adding or removing member content items (e.g., a message or like), while others are general interactions (e.g., posting a status update) and are not related to another particular member. Thus, if a given member interaction is directed towards or includes a specific member, that member is also included in the membership interaction record.

In some example embodiments, the member profile data 130 includes educational material access history data 132. In some example embodiments, educational material access history data 132 includes one or more material access records, each of which details a particular instance of the member accessing a particular piece of educational material. In some example embodiments, each material access records the member who accessed the educational materials, the time of the access, the course associated with the educational materials, how much of the educational materials was read, watched, listened to, or completed.

In some example embodiments, the education material data 134 includes educational materials. Each piece of educational material is a media content item. Media content items include text items, video content items, audio content items, interactive content items (e.g., quizzes and so on), and any other materials that can be used in an educational course. In some example embodiments, each piece of educational material is associated with a specific educational course.

Once registered, a member may invite other members, or be invited by other members, to connect via the server system 120. A “connection” may include a bilateral agreement by the members, such that both members acknowledge the establishment of the connection. Similarly, in some example embodiments, a member may elect to “follow” another member. In contrast to establishing a “connection,” the concept of “following” another member typically is a unilateral operation and, at least in some example embodiments, does not include acknowledgement or approval by the member that is being followed. When one member follows another, the member who is following may receive automatic notifications about various interactions undertaken by the member being followed. In addition to following another member, a member may elect to follow a company, a topic, a conversation, or some other entity, which may or may not be included in the social graph. Various other types of relationships may exist between different entities, and are represented in the social graph data 138.

The server system 120 may provide a broad range of other applications and services that allow members the opportunity to share and receive information, often customized to the interests of the member. In some example embodiments, the server system 120 may include a photo sharing application that allows members to upload and share photos with other members. As such, at least in some example embodiments, a photograph may be a property or entity included within a social graph. In some example embodiments, members of the server system 120 may be able to self-organize into groups, or interest groups, organized around a subject matter or topic of interest. In some example embodiments, the data for a group may be stored in a database. When a member joins a group, his or her membership in the group will be reflected in the member profile data 130 and the social graph data 138.

In some example embodiments, the application logic layer includes various application server modules, which, in conjunction with the user interface module(s) 122, generate various user interfaces (e.g., web pages) with data retrieved from various data sources in the data layer. In some example embodiments, individual application server modules are used to implement the functionality associated with various applications, services, and features of the server system 120. For instance, a messaging application, such as an email application, an instant messaging application, or some hybrid or variation of the two, may be implemented with one or more application server modules. Similarly, a search engine enabling members to search for and browse member profiles may be implemented with one or more application server modules.

A material access recording module 124 or a clustering module 126 can also be included in the application logic layer. Of course, other applications or services that utilize the material access recording module 124 or the clustering module 126 may be separately implemented in their own application server modules.

As illustrated in FIG. 1, in some example embodiments, the material access recording module 124 and the clustering module 126 are implemented as services that operate in conjunction with various application server modules. For instance, any number of individual application server modules can invoke the functionality of the material access recording module 124 and the clustering module 126. However, in various alternative example embodiments, the material access recording module 124 and the clustering module 126 may be implemented as their own application server modules such that they operate as standalone applications.

Generally, the material access recording module 124 tracks each time a member accesses the education material data 134. In some example embodiments, each access is stored in the educational material access history data 132 of the member profile data 130. In some example embodiments, the material access recording module 124 tracks when a member begins accessing an educational content item and when the member ceases to access it. In this way, the material access recording module 124 can determine which educational content items are used by which members, which sections of a particular educational content item are the most accessed (e.g., if the first 10 minutes of a video are very popular but the remaining 10 minutes are not usually watched), how long members access particular educational content items, which sections the members interact with, and so on.

In this way, the material access recording module 124 is able to record a large amount of data detailing which members access particular educational content items and which sections of particular educational content items are accessed. In some example embodiments, the data is collected and stored for each member, such that each member's specific content accessing history is stored and associated with that particular member. In other example embodiments, the data is collected and personal information is removed from the data such that general patterns and trends are retained but personal information is not associated with the general content accessing trends.

In some example embodiments, the recorded data about accessing particular educational content items is stored by the material access recording module 124 in the educational material access history data 132. In some example embodiments, the data is then accessed by the clustering module 126.

In some example embodiments, the clustering module 126 analyzes data stored in the educational material access history data 132. Using this data (e.g., data describing which educational content items each member has accessed), the clustering module 126 clusters members into a plurality of use groups based on which educational content items the members view.

For example, members who tend to view educational materials for running a small business are grouped together, even if the specific materials that are viewed are drawn from different educational groupings (the original groupings for the educational content). In some example embodiments, a variety of clustering techniques can be employed to group these members into clusters based on their viewing habits.

In some example embodiments, the clustering module 126 also groups educational content items stored in the education material data 134 into a plurality of similar topic groupings. For example, if a particular course is sorted into the computer science section of the server system 120 but it is primarily viewed by members who run web-based businesses, it will be clustered into the web-based business content group.

In some example embodiments, once members and/or content items have been grouped into clusters based on member viewing habits, the clustering module 126 determines various characteristics of the different clusters. For example, clusters of members can be analyzed to determine the average number of educational content items the members access, how long the members of the cluster use the server system 120 on average, the clusters that are most likely to refer or invite other members, and so on. With this information, the server system (e.g., the server system 120 in FIG. 1) can target offers, discounts and advertisements to the members who belong to certain cluster groups.

For example, if cluster group A members subscribe to the server system (e.g., the server system 120 in FIG. 1) for more months than other cluster groups on average, members who are clustered into cluster group A will be offered a discount to their monthly subscription fee. In other example embodiments, the clustering module 126 identifies clusters for which additional educational content (e.g., new courses) would be the most impactful

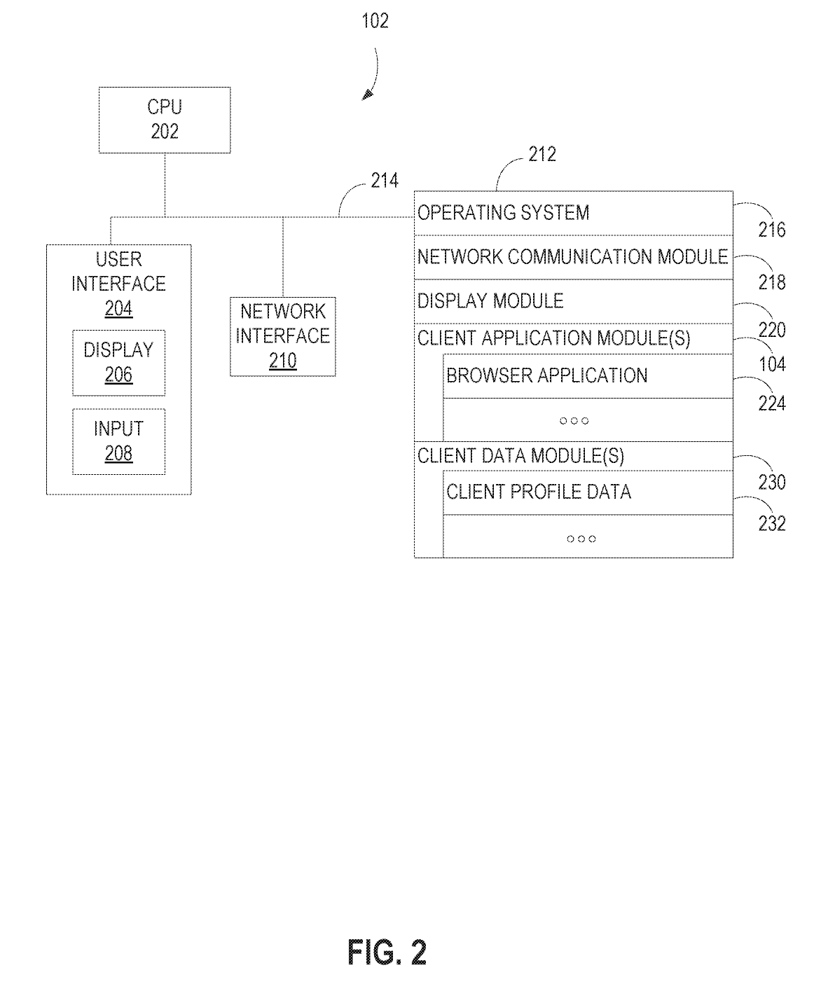

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means 208 such as a keyboard, a mouse, a touch sensitive display, or other input buttons. Furthermore, some client systems 102 use a microphone and voice recognition to supplement or replace the keyboard.

The memory 212 includes high-speed random-access memory, such as dynamic random-access memory (DRAM), static random-access memory (SRAM), double data rate random-access memory (DDR RAM), or other random-access solid state memory devices; and may include non-volatile memory, such as one or more magnetic disk storage devices, optical disk storage devices, flash memory devices, or other non-volatile solid state storage devices. The memory 212 may optionally include one or more storage devices remotely located from the CPU(s) 202. The memory 212, or alternatively, the non-volatile memory device(s) within the memory 212, comprise(s) a non-transitory computer-readable storage medium.

In some example embodiments, the memory 212, or the computer-readable storage medium of the memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more network interfaces 210 (wired or wireless) and one or more communication networks 110, such as the Internet, other WANs, LANs, metropolitan area networks (MANs), etc.;
a display module 220 for enabling the information generated by the operating system 216 and client application(s) 104 to be presented visually on the display device 206;
one or more client applications modules 104 for handling various aspects of interacting with the server system 120 (FIG. 1), including but not limited to:
   a browser application 224 for requesting information from the server system 120 (e.g., job listings) and receiving responses from the server system 120; and
client data module(s) 230 for storing data relevant to clients, including but not limited to:
   client profile data 232 for storing profile data related to a member of the server system 120 associated with the client system 102.

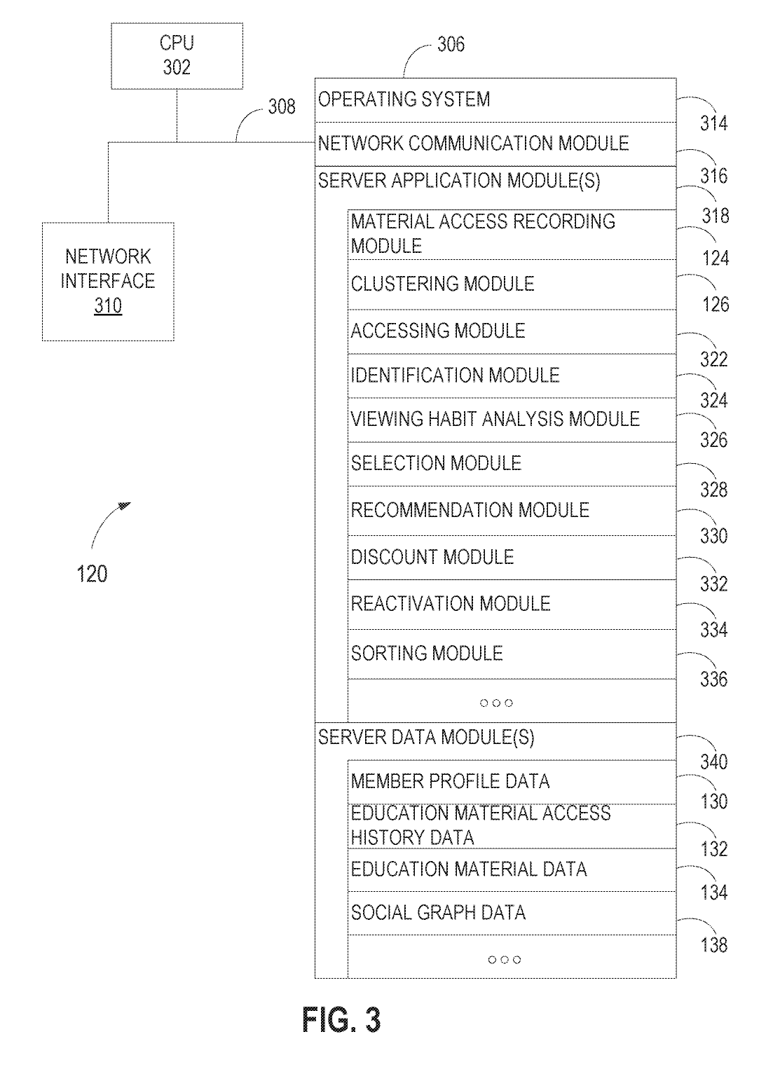

FIG. 3 is a block diagram further illustrating the server system 120, in accordance with some example embodiments. Thus, FIG. 3 is an example embodiment of the server system 120 in FIG. 1. The server system 120 typically includes one or more CPUs 302, one or more network interfaces 310, memory 306, and one or more communication buses 308 for interconnecting these components. The memory 306 includes high-speed random-access memory, such as DRAM, SRAM, DDR RAM, or other random-access solid state memory devices; and may include non-volatile memory, such as one or more magnetic disk storage devices, optical disk storage devices, flash memory devices, or other non-volatile solid state storage devices. The memory 306 may optionally include one or more storage devices remotely located from the CPU(s) 302.

The memory 306, or alternatively the non-volatile memory device(s) within the memory 306, comprises a non-transitory computer-readable storage medium. In some example embodiments, the memory 306, or the computer-readable storage medium of the memory 306, stores the following programs, modules, and data structures, or a subset thereof:
an operating system 314 that includes procedures for handling various basic system services and for performing hardware-dependent tasks;
a network communication module 316 that is used for connecting the server system 120 to other computers via the one or more network interfaces 310 (wired or wireless) and one or more communication networks 110, such as the Internet, other WANs, LANs, MANs, and so on;
one or more server application modules 318 for performing the services offered by the server system 120, including but not limited to:
   a material access recording module 124 for recording each instance of a member accessing a specific educational content item from the education material data 134;
   a clustering module 126 for grouping both members and educational courses based on an analysis of which members access educational content for each particular course, such data being stored in the educational material access history data 132;
   an accessing module 322 for accessing data describing member interactions with the education material data 134 (e.g., members viewing videos and so on);
   an identification module 324 for identifying, for a particular member, which courses the member has accessed and for a particular course, which members have accessed it;
   a viewing habit analysis module 326 for determining, based on a member's record of accessing educational materials, one or more patterns associated with the member's viewing habits;
   a selection module 328 for selecting one or more courses for recommendation for a member based on the member's viewing habits;
   a recommendation module 330 for recommending appropriate courses or educational material to a member based on a selection of appropriate materials or courses;
   a discount module 332 for determining a discount to offer to a member based on the interest grouping associated with the member;
   a reactivation module 334 for identifying a particular member for activation emails (or other efforts) based on a determined interest grouping for the members; and
   a sorting module 336 for sorting members into one of two groups of members based on the member quality score associated with each member; and
server data module(s) 340, holding data related to the server system 120, including but not limited to:
   member profile data 130, including both data provided by the member, who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on the member's activity, social graph data 138, overall trend data for the server system 120, and so on;
   education material access history data 132 including data describing each instance in which a member accesses an educational content item stored in the education material data 134;
   education material data 134 including data for a plurality of educational courses, each course having a plurality of educational content items (e.g., videos, text, audio material, interactive materials, and so on); and
   social graph data 138 including data that represents members of the server system 120 and the social connections between them.

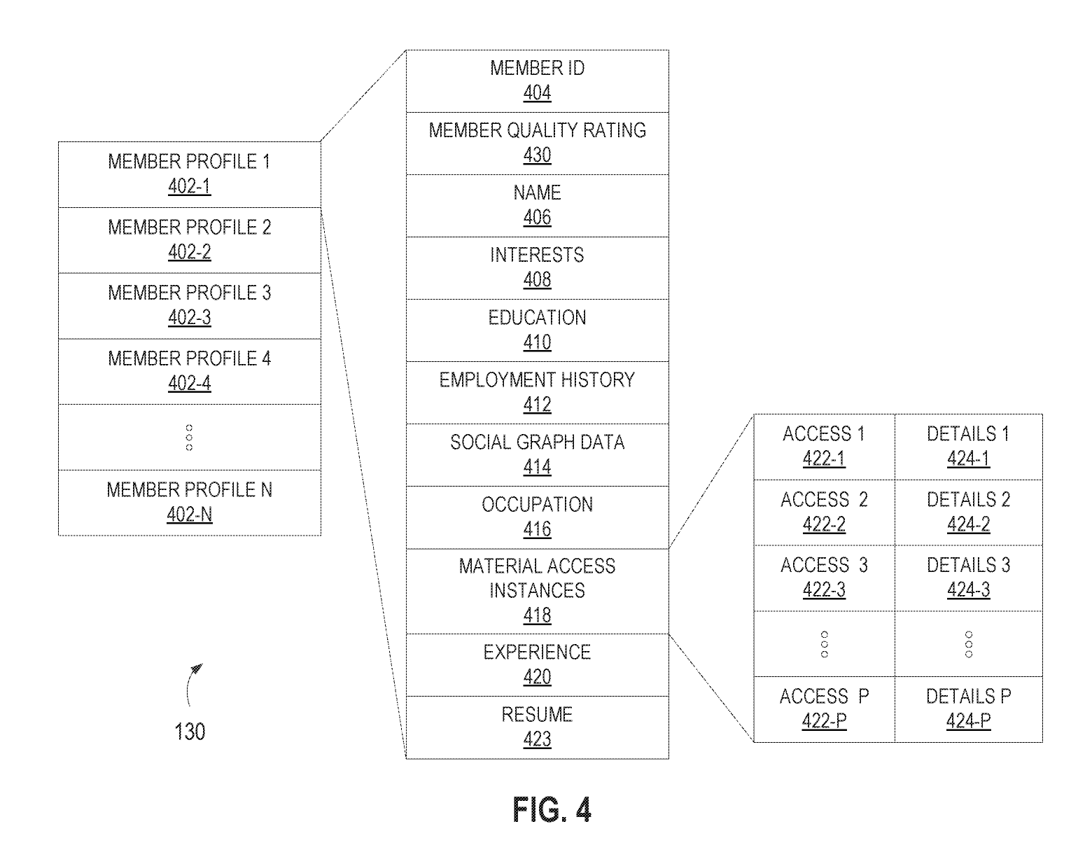

FIG. 4 is a block diagram of an exemplary data structure for the member profile data 130 for storing member profiles, in accordance with some example embodiments. In accordance with some example embodiments, the member profile data 130 includes a plurality of member profiles 402-1 to 402-N, each of which corresponds to a member of the server system 120.

In some example embodiments, a respective member profile 402 stores a unique member ID 404 for the member profile 402, a member quality rating 430 for the member, a name 406 for the member (e.g., the member's legal name), member interests 408, member education history 410 (e.g., the high school and universities the member attended and the subjects studied), employment history 412 (e.g., the member's past and present work history with job titles), social graph data 414 (e.g., a listing of the member's relationships as tracked by the server system 120), occupation 416, material access instances 418, experience 420 (for listing experiences that do not fit under other categories, such as community service or serving on the board of a professional organization), and a detailed member resume 423.

In some example embodiments, the material access instances 418 include a list of material access instances 422-1 to 422-P (each instance wherein a member accesses an educational content item from the educational material data 132) and associated instance details 424-1 to 424-P. Each instance 422-1 to 422-P describes one instance of a member accessing a single educational content item, including but not limited to a member viewing a video or other content item. Each instance 422-1 to 422-P is recorded and stored in the educational material access history data 132 at the server system 120.

The details 424-1 to 424-P associated with each instance 422-1 to 422-P record which educational content item was accessed, which course the content item is associated with, the amount of time the member spent viewing or otherwise interacting with the content item, the member's starting place and finishing place (e.g., in a video), the time the content item was accessed, the member's results (if the educational content item is interactive (e.g., a quiz or project)), and so on.

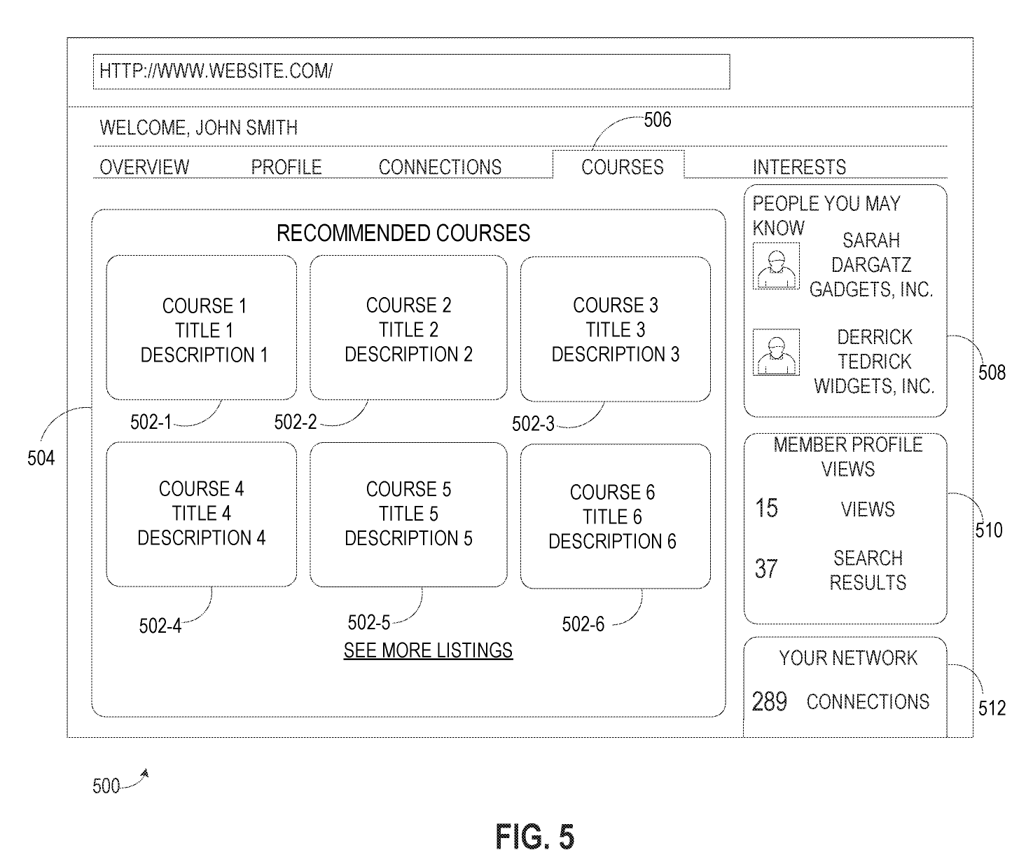

FIG. 5 is a user interface diagram illustrating an example of a user interface 500 or web page that incorporates one or more course recommendations for courses available at a server system (e.g., the server system 120 in FIG. 1). In the example user interface 500 of FIG. 5A, the displayed user interface 500 represents a web page for a member of the server service with the name John Smith.

As can be seen, a courses tab 506 has been selected and a page of course recommendations 504 is displayed. The course recommendations 504 include a plurality of courses 502-1 to 502-6, wherein each course 502 displays a course title and a description. Members can then select a particular course 502 to get additional information and the ability to enroll in the course 502 or access educational materials associated with the course 502.

The user interface 500 also includes information in side sections of the user interface 500 including a contact recommendation section 508, a profile viewership statistic section 510, and a social graph statistic section 512.

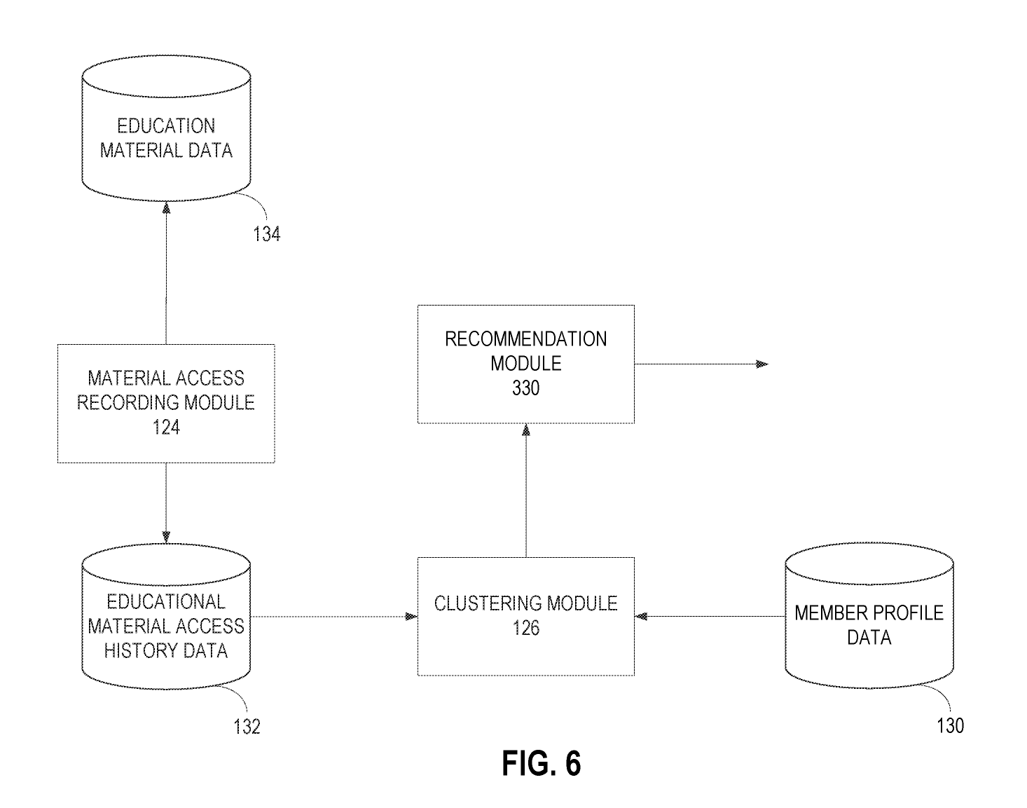

FIG. 6 is a flow diagram illustrating a method, in accordance with some example embodiments, for grouping members and courses based on member course access records. Each of the operations shown in FIG. 6 may correspond to instructions stored in a computer memory or computer-readable storage medium. In some embodiments, the method described in FIG. 6 is performed by a server system (e.g., server system 120 in FIG. 1). However, the method described can also be performed by any other suitable configuration of electronic hardware.

In some embodiments, the method is performed by a server system (e.g., server system 120 in FIG. 1) including one or more processors and memory storing one or more programs for execution by the one or more processors.

In some example embodiments, the material access recording module 124 records instances in which members of the server system (e.g., server system 120 in FIG. 1) access educational content items from the education material data 134.

For example, a member accesses a video associated with a particular course offered through the server system (e.g., the server system 120 in FIG. 1). The material access recording module 124 detects the access of the education material data 134 (when the video data is stored in the education material data 134) and creates a record for the member in the educational material access history data 132.

In some example embodiments, the record includes an identifier of the member, the particular content item the member accesses, when the content item was accessed, what particular sections of the content item the member accesses, the duration of the access, and any other pertinent information.

In some example embodiments, each record is then stored in the educational material access history data 132. In some example embodiments, the clustering module 126 accesses records in the educational material access history data 132 to develop a data model that represents each member and lists the courses and educational content items that the member has accessed. The clustering module 126 then uses clustering techniques to group courses offered by the server system (e.g., the server system 120 in FIG. 1) into one or more course groupings based on the member access records.

For example, the viewing records of members can be used to determine which courses are viewed by similar members. In this way, the clustering module 126 can create a series of course groupings based on underlying commonality that results in similar member viewing them.

Similarly, the clustering module 126 can group members into one or more interest groups, wherein the interest groups represent members who have similar interests based on their educational content viewing history. In some example embodiments, the clustering group can also use member data from the member profile data 130.

Once the clustering module 126 has grouped both members and courses into interest groups, the recommendation module 330 can then make recommendations based on that grouping. For example, if a member has accessed one or more courses and wants a recommendation for another course to access, the recommendation module 330 determines an interest group that the member is grouped into based on their recorded course access history.

Once an interest group is determined, the recommendation module 330 can determine which courses, of the courses that the member has not yet accessed, are most popular among other members of the interest group. For example, the recommendation module 330 lists the courses that more than one member of the interest group have accessed, ranked by the number of members who have accessed them. The recommendation module 330 then chooses the course with the most number of views for which the member meets the requirements and that the member has not yet accessed.

In other example embodiments, the recommendation module 330 determines which interest group of courses would be the best candidate for additional courses or materials. The different course groups can be ranked by average income and then the course groups with the higher than average income will be recommended for additional content generation.

In some example embodiments, the recommendation generated by the recommendation module 330 is transmitted to a client system (e.g., the client system 102 in FIG. 1) for presentation to a member.

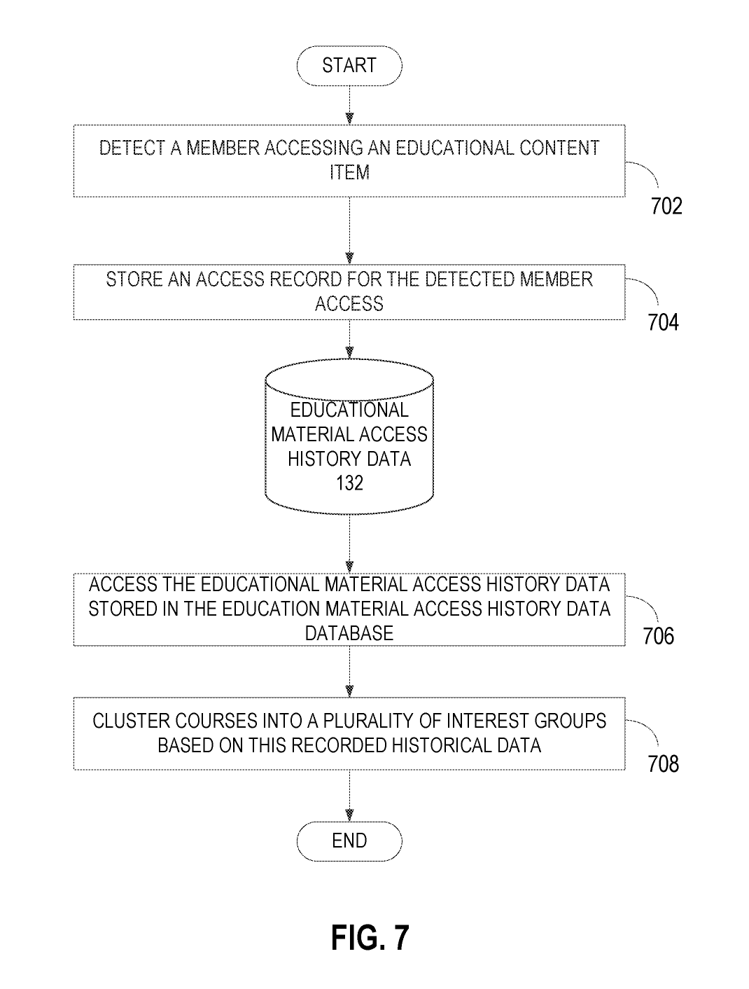

FIG. 7 is a flow diagram illustrating a method, in accordance with some example embodiments, for grouping courses in a multi-course educational system at a server system (e.g., server system 120 in FIG. 1). Each of the operations shown in FIG. 7 may correspond to instructions stored in a computer memory or computer-readable storage medium. Optional operations are indicated by dashed lines (e.g., boxes with dashed-line borders). In some embodiments, the method described in FIG. 7 is performed by the server system (e.g., server system 120 in FIG. 1). However, the method described can also be performed by any other suitable configuration of electronic hardware.

In some embodiments the method is performed by a server system (e.g., server system 120 in FIG. 1) including one or more processors and memory storing one or more programs for execution by the one or more processors.

In some example embodiments, the server system (e.g., server system 120 in FIG. 1) detects (702) a member accessing an educational content item (e.g., a video, text, image, interactive media, and so on). The server system (e.g., the server system 120 in FIG. 1) determines the identity (e.g., membership identification number) of the member who accesses the educational content item.

For example, when a content request is sent to the server system (e.g., the server system 120 in FIG. 1), the request includes a member identification number that allows the server system (e.g., the server system 120 in FIG. 1) to determine whether that member has access to the requested course content. In some example embodiments, the server system (e.g., the server system 120 in FIG. 1) also determines the course associated with the accessed educational content item.

In some example embodiments, the server system (e.g., the server system 120 in FIG. 1) stores (704) an access record for the detected member access. In some example embodiments, the access record includes data indicating the member who initiated the access and the course associated with the educational content item that was accessed.

In some example embodiments, the access records are stored in the educational material access history data 132. In other example embodiments, the educational material access history data 132 includes a series of course records. Each course record includes a list of members who have accessed educational content items associated with the course.

The server system (e.g., the server system 120 in FIG. 1) then accesses (706) the educational material access history data 132. The server system (e.g., the server system 120 in FIG. 1) uses this history data to cluster (708) courses into a plurality of interest groups based on this recorded historical data. For example, the clustering algorithm groups courses based on which courses a certain type of member tends to access. In this way, course similarities that are unclear when the courses were originally created can be discovered and analyzed.

In some example embodiments, the members can also be clustered into interest groups based on their past course history. In some example embodiments, members who have similar course viewing habits will be grouped into a member cluster, even if they self-describe as different categories or otherwise appear to have few similarities. Clustering can be accomplished with a wide variety of clustering algorithms. One example algorithm includes K meaning clustering. To use K-means clustering for members, each member is assigned a position in n-dimensional Euclidean space (based on courses accessed). Each member is assigned to a cluster whose center point is the closest using an equation such as:

Sᵢ^{(t)}={xₚ:|xₚ−mᵢ^{(t)}|I²≦|xₚ−mⱼ^{(t)}|I²∀j, 1≦j≦k}

Where each member (x) is assigned to one cluster S, based on which center point (M with coordinates i, j) is closest to the position of the member in the space.

Once members have been assigned to clusters, the central point of the clusters is updated with a formula such as:

$${m}_{i}^{t + 1} = \frac{1}{{S}_{i}^{( t )}} {\sum }_{{x}_{j ∈ {S}_{i}^{( t )}}} {x}_{j}$$

Once new central points are determined, the members are clustered again. Once the members stop shifting between clusters, the clusters are determined to have settled.

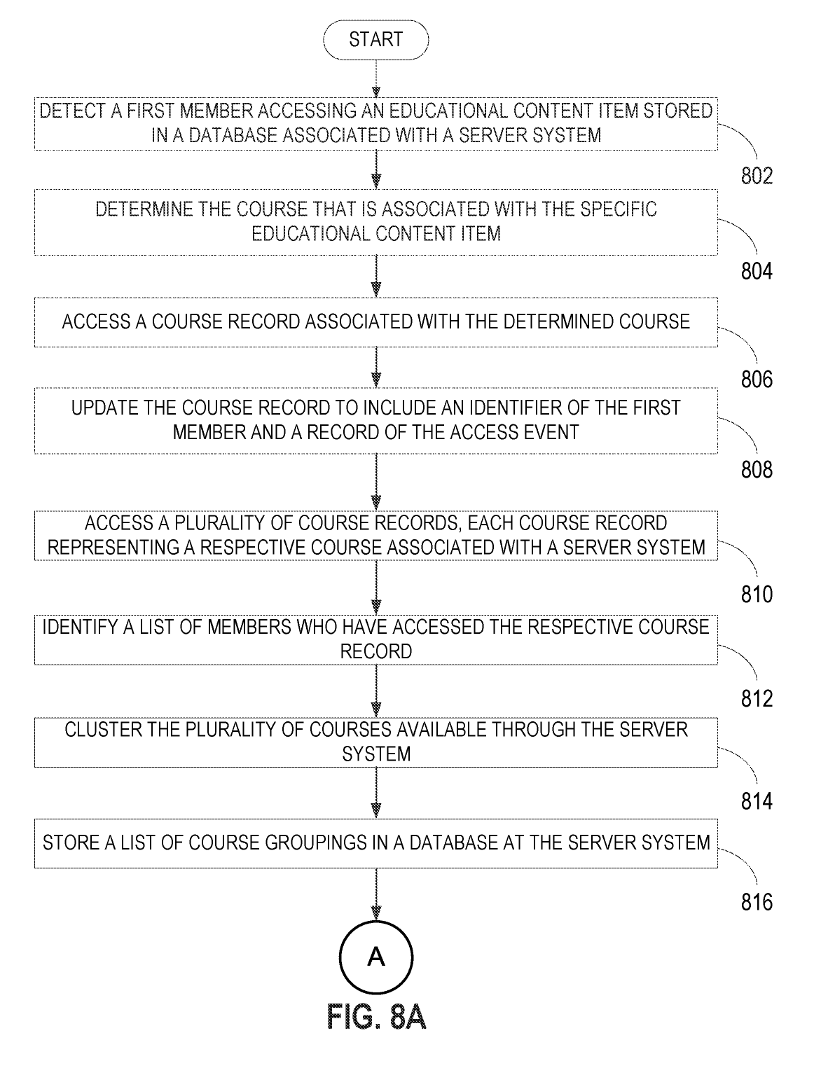

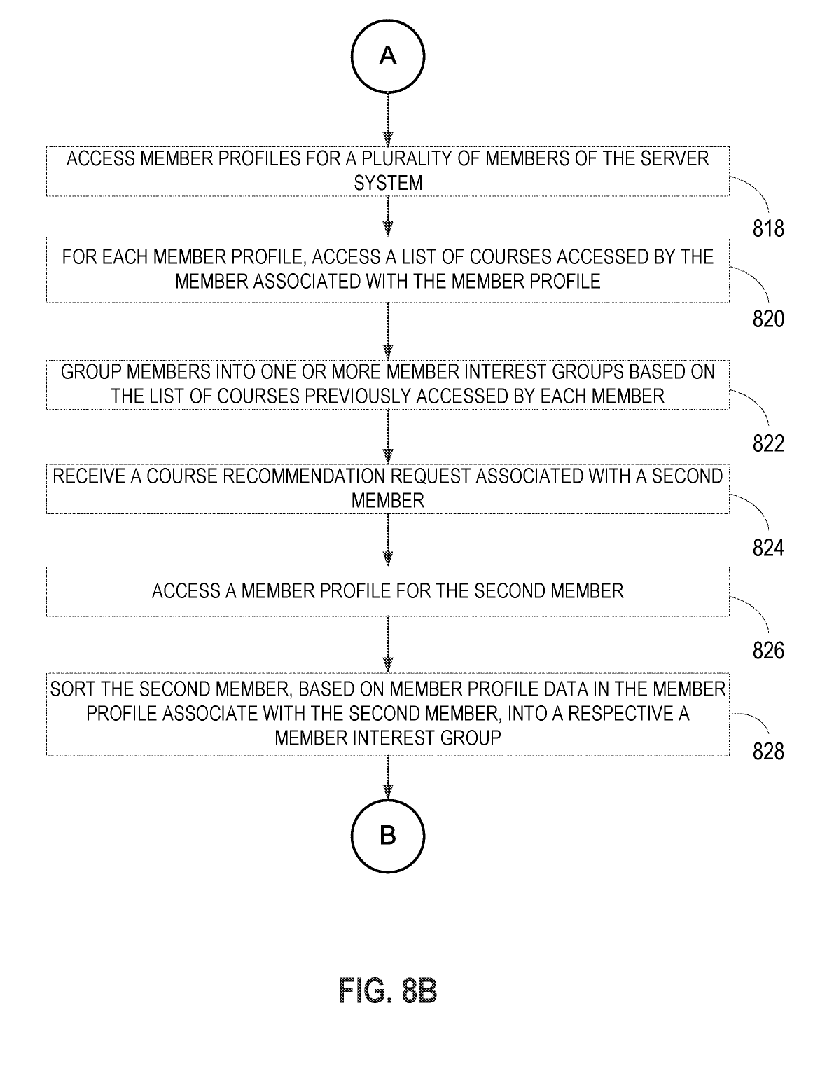

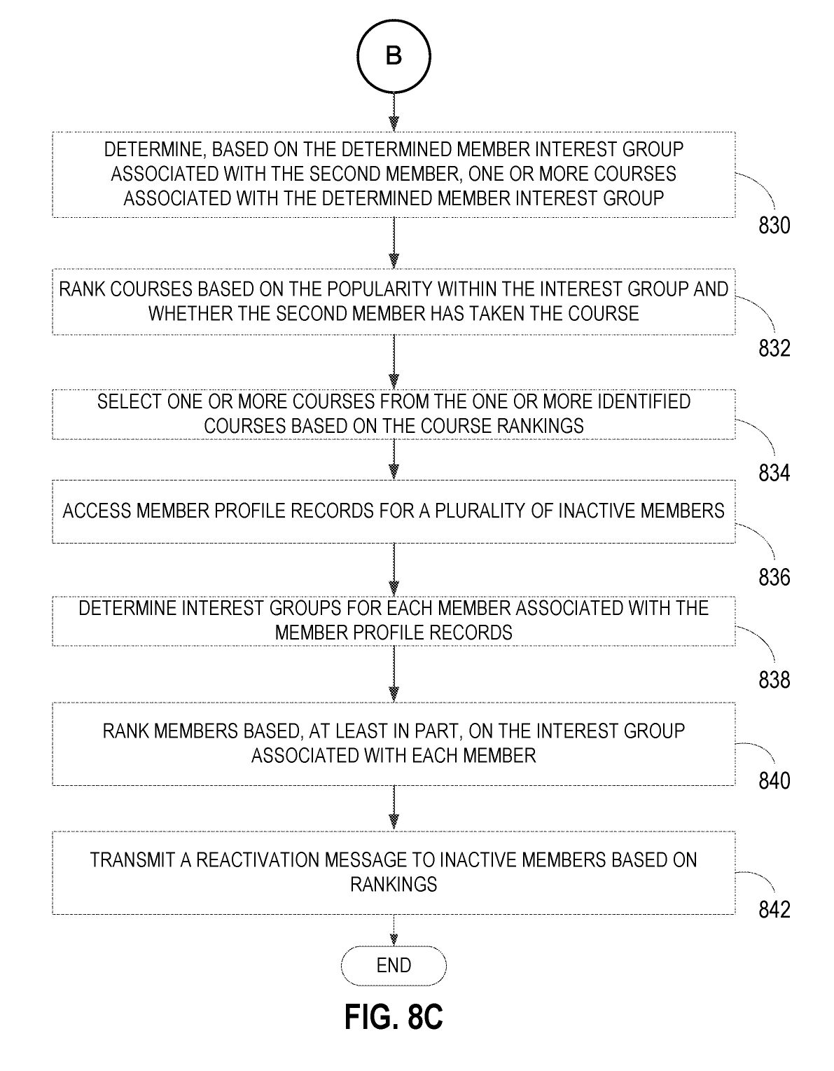

FIG. 8A is a flow diagram illustrating a method, in accordance with some example embodiments, for grouping courses in a multi-course educational system at a server system (e.g., server system 120 in FIG. 1). Each of the operations shown in FIG. 8A may correspond to instructions stored in a computer memory or computer-readable storage medium. Optional operations are indicated by dashed lines (e.g., boxes with dashed-line borders). In some embodiments, the method described in FIG. 8A is performed by the server system (e.g., server system 120 in FIG. 1). However, the method described can also be performed by any other suitable configuration of electronic hardware.

In some embodiments the method is performed by a server system (e.g., server system 120 in FIG. 1) including one or more processors and memory storing one or more programs for execution by the one or more processors.

In some example embodiments, a server system (e.g., the server system 120 in FIG. 1) detects (802) a first member accessing an educational content item stored in a database associated with a server system. In some example embodiments, the server system (e.g., the server system 120 in FIG. 1) maintains a database of course materials (e.g., any educational content item). When a member chooses a particular educational content item to access (e.g., by selecting a particular course and loading the next content item or by selecting particular content item), an access request is transmitted to the database. The server system (e.g., the server system 120 in FIG. 1) can then detect these access requests.

In some example embodiments, when the server system (e.g., the server system 120 in FIG. 1) detects an access request for any of the educational content items, the server system (e.g., the server system 120 in FIG. 1) determines (804) the course that is associated with the specific educational content item. For example, if the member access a particular video, the server system (e.g., the server system 120 in FIG. 1) determines which course that video corresponds to.

Once the course associated with the accessed educational content item is determined, the server system (e.g., the server system 120 in FIG. 1) accesses (806) a course record associated with the determined course. For example, if the accessed education content item is an interactive quiz associated with course A, the server system (e.g., the server system 120 in FIG. 1) accesses the course record for course A. In some example embodiments, a course record is a record of members who have accessed materials belonging to the course.

In some example embodiments, the course records also include details concerning when the member accessed the educational content item, which sections the member viewed (e.g., which pages or what times), and any received member responses (e.g., for an interactive educational content item).

In other example embodiments, the server system (e.g., the server system 120 in FIG. 1) accesses a member record that describes the member's history of accessing the educational content item.

In some example embodiments, the server system (e.g., the server system 120 in FIG. 1) updates (808) the course record to include an identifier of the first member and a record of the access event. Thus, the updated course record will include the first member among its list of members who have accessed materials associated with the course.

In some example embodiments, the server system (e.g., the server system 120 in FIG. 1) accesses (810) a plurality of course records, each course record representing a respective course associated with a server system (e.g., the server system 120 in FIG. 1). In some example embodiments, the course records are organized into a plurality of original course groups. The original course groups are created by applying a criteria to the courses. For example, plurality of courses are grouped into a first group of courses and a second group of courses, the first group of courses associated with a first topic and the second group of courses associated with a second topic. In some example embodiments, the original course groups are determined manually and form a hierarchical structure that the server system uses to arrange current courses by topic for the members to more easily find a desired course.

For each respective course record, the server system (e.g., the server system 120 in FIG. 1) identifies (812) a list of members who have accessed the respective course record. For example, the server system (e.g., the server system 120 in FIG. 1) determines that five members have accessed content for Course C (although the actual numbers of members are much higher).

In some example embodiments, the server system (e.g., the server system 120 in FIG. 1) clusters (814) the plurality of courses available through the server system (e.g., the server system 120 in FIG. 1) based on analyzing the list of members who accessed each course to automatically create a plurality of course groupings. For example, the server system (e.g., the server system 120 in FIG. 1) uses a clustering and/or grouping algorithm. Example clustering algorithms include but are not limited to connectivity based clustering techniques (hierarchical clustering or linkage based clustering), centroid-based clustering techniques (k-means clustering), distribution-based clustering techniques (e.g., expectation-maximization clustering), density-based clustering techniques, and so on.

In some example embodiments, the social networking system (e.g., the social networking system 120 in FIG. 1) server system (e.g., the server system 120 in FIG. 1) applying a clustering algorithm to each particular course in either the first group of courses or the second group of courses to create a third group of courses wherein the third group of courses are grouped according to the list of members that have accessed content associated with each particular course and the third group of courses includes at least one course selected from the first group of courses and at least one course selected from the second group of courses.

In some example embodiments, the server system (e.g., the server system 120 in FIG. 1) creates a fourth group of courses wherein the fourth group of courses are grouped according to the list of members that have accessed content associated with each particular course, the fourth group of courses includes at least one course selected from the first group of courses and at least one course selected from the second group of courses but no courses that were included in the third group of courses.

In some example embodiments, the server system (e.g., the server system 120 in FIG. 1) determines member demand for courses included in the third group of courses. For example, the server system (e.g., the server system 120 in FIG. 1) calculates the engagement of members with each determined group of courses. Once the average engagement is determined (the number of members who access course in the group, divided by the total number of courses in the groups. The groups with high number of course accesses per course will be determined to have high customer demand. In some example embodiments, the server system (e.g., the server system 120 in FIG. 1) determines an average customer demand value and uses that value as a threshold such that course groups above the threshold are determined to be in demand.

In accordance with a determination that the member demand for courses in included in the third group of courses is equal to or greater than a member demand threshold, the server system (e.g., the server system 120 in FIG. 1) transmits a request for additional course content to a content provider.

In some example embodiments, the server system (e.g., the server system 120 in FIG. 1) stores (816) a list of course groupings in a database at the server system. Thus, the server system (e.g., the server system 120 in FIG. 1) stores a series of course groupings that define one or more groups of courses based on past member use history.

FIG. 8B is a flow diagram illustrating a method, in accordance with some example embodiments, for generating a member quality score for members of a server system (e.g., server system 120 in FIG. 1). Each of the operations shown in FIG. 8B may correspond to instructions stored in a computer memory or computer-readable storage medium. Optional operations are indicated by dashed lines (e.g., boxes with dashed-line borders). In some embodiments, the method described in FIG. 8B is performed by the server system (e.g., server system 120 in FIG. 1). However, the method described can also be performed by any other suitable configuration of electronic hardware.

In some embodiments the method is performed by a server system (e.g., server system 120 in FIG. 1) including one or more processors and memory storing one or more programs for execution by the one or more processors.

In some example embodiments, the server system (e.g., the server system 120 in FIG. 1) accesses (818) member profiles for a plurality of members of the server system (e.g., the server system 120 in FIG. 1). In some example embodiments, a database at the server system (e.g., the server system 120 in FIG. 1) stores a plurality of member profiles. In some example embodiments, the member profiles include a list of courses (or content items) accessed by the member associated with the member profile. In some example embodiments, the member profile data includes specific information about each access instance including, but not limited to, the specific sections viewed (e.g., which part of the video or text is actually displayed), whether the member completed the course, and so on.

For each member profile, the server system (e.g., the server system 120 in FIG. 1) accesses (820) a list of courses accessed by the member associated with the member profile. In some example embodiments, the server system (e.g., the server system 120 in FIG. 1) groups (822) members into one or more member interest groups based on the list of courses previously accessed by each member. For example, if two members have accessed course materials for the same courses, the server system (e.g., the server system 120 in FIG. 1) will likely group them together in a common interest group regardless of the stated intention of the members. Similarly, if two members self-identify as being interested in small business courses, but have very limited course overlap, the server system (e.g., the server system 120 in FIG. 1) may group them into different interest groups.

In some example embodiments, the server system (e.g., the server system 120 in FIG. 1) receives (824) a course recommendation request associated with a second member. For example, the course recommendation request is generated based on a specific request from the second member. In other example embodiments, the course recommendation request is generated automatically in response to a member action that does not explicitly request a course recommendation, such as loading a web page that includes a portion dedicated to course suggestions.

In some example embodiments, the server system (e.g., the server system 120 in FIG. 1) accesses (826) a member profile for the second member. The member profile contains a variety of information about the second member.

In some example embodiments, the server system (e.g., the server system 120 in FIG. 1) sorts (828) the second member, based on member profile data in the member profile associate with the second member, into a respective a member interest group. Thus, the server system (e.g., the server system 120 in FIG. 1) uses pre-established interest groupings of members as a model for determining which interest group the second member should be grouped into. In other example embodiments, the member has already been grouped based on the past course viewing data for the member and the server system (e.g., the server system 120 in FIG. 1) just accesses that grouping data.

FIG. 8C is a flow diagram illustrating a method, in accordance with some example embodiments, for generating a member quality score for members of a server system (e.g., server system 120 in FIG. 1). Each of the operations shown in FIG. 8C may correspond to instructions stored in a computer memory or computer-readable storage medium. Optional operations are indicated by dashed lines (e.g., boxes with dashed-line borders). In some embodiments, the method described in FIG. 8C is performed by the server system (e.g., server system 120 in FIG. 1). However, the method described can also be performed by any other suitable configuration of electronic hardware.

In some embodiments the method is performed by a server system (e.g., server system 120 in FIG. 1) including one or more processors and memory storing one or more programs for execution by the one or more processors.

In some example embodiments, the server system (e.g., the server system 120 in FIG. 1) determines (830), based on the determined member interest group associated with the second member, one or more courses associated with the determined member interest group. For example, an interest group for members includes a list of the most commonly accessed courses of members who are included in the interest group. The server system (e.g., the server system 120 in FIG. 1) identifies, for each respective common course associated with the interest group, whether the second member has already accessed (or taken) that respective course.

In some example embodiments, the server system (e.g., the server system 120 in FIG. 1) ranks each of the one or more identified courses based on the past course access history of the second member. In some example embodiments, courses that are similar to courses the member has already take are ranked highly (e.g., by estimating the distance between courses).

In other example embodiments, the server system (e.g., the server system 120 in FIG. 1) ranks (832) courses based on the popularity within the interest group and whether the second member has taken the course. In this way, courses that have been taken by a large number of members of the interest group (but not the second member) would have a higher rank than courses that have been taken by fewer of the members of the interest group.

In some example embodiments, the server system (e.g., the server system 120 in FIG. 1) selects (834) one or more courses from the one or more identified courses based on the course rankings. For example, the server system (e.g., the server system 120 in FIG. 1) selects the highest ranked course.

In some example embodiments, the server system (e.g., the server system 120 in FIG. 1) transmits the one or more selected courses to the client system for presentation. For example, the recommendation is presented in a webpage on a screen associated with the second member.

In some example embodiments, the server system (e.g., the server system 120 in FIG. 1) accesses (836) member profile records for a plurality of inactive members. For example, the server system (e.g., the server system 120 in FIG. 1) keeps a record of member signups and a current list of active members (e.g., currently paying a subscription or having accessed a service within a particular time period) and can access a list of members who are no longer actively engaging with the server system (e.g., the server system 120 in FIG. 1).

In some example embodiments, the server system the server system 120 in FIG. 1) determines (838) interest groups for each inactive member associated with the member profile records. The server system (e.g., the server system 120 in FIG. 1) then ranks (840) members based, at least in part, on the interest group associated with each member. For example, if a first interest group is associated with a higher average retention rate or average yearly income, members of that interest group may be ranked higher than members grouped into a different interest group.

In some example embodiments, the server system (e.g., the server system 120 in FIG. 1) transmits (842) a reactivation message to inactive members based on rankings. In some example embodiments, the reactivation message includes a discount offer.

In some example embodiments, the server system (e.g., the server system 120 in FIG. 1) calculates an average retention rate for a particular member interest group based on the retention length of the members in the particular member interest group. For example, the server system (e.g., the server system 120 in FIG. 1) determines a total number of subscription months for each member (active or inactive) in the member interest group and divides that total by the number of members in that interest group.

The server system (e.g., the server system 120 in FIG. 1) determines whether the average retention rate for the particular member interest group exceeds a predetermined threshold. For example, if the predetermined retention rate threshold is 6 months, then the system would determine whether the average retention rate for a particular member interest group is longer than six months.

In response to a determination that the average retention rate for the particular member interest group exceeds a predetermined threshold, the server system (e.g., the server system 120 in FIG. 1) identifies one or more inactive members within the particular member interest group; wherein an inactive member is a member that has not logged into the content server system within a predetermined time frame. The server system (e.g., the server system 120 in FIG. 1) then transmits a reactivation message to the one or more inactive members within the particular member interest group

### Software Architecture

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

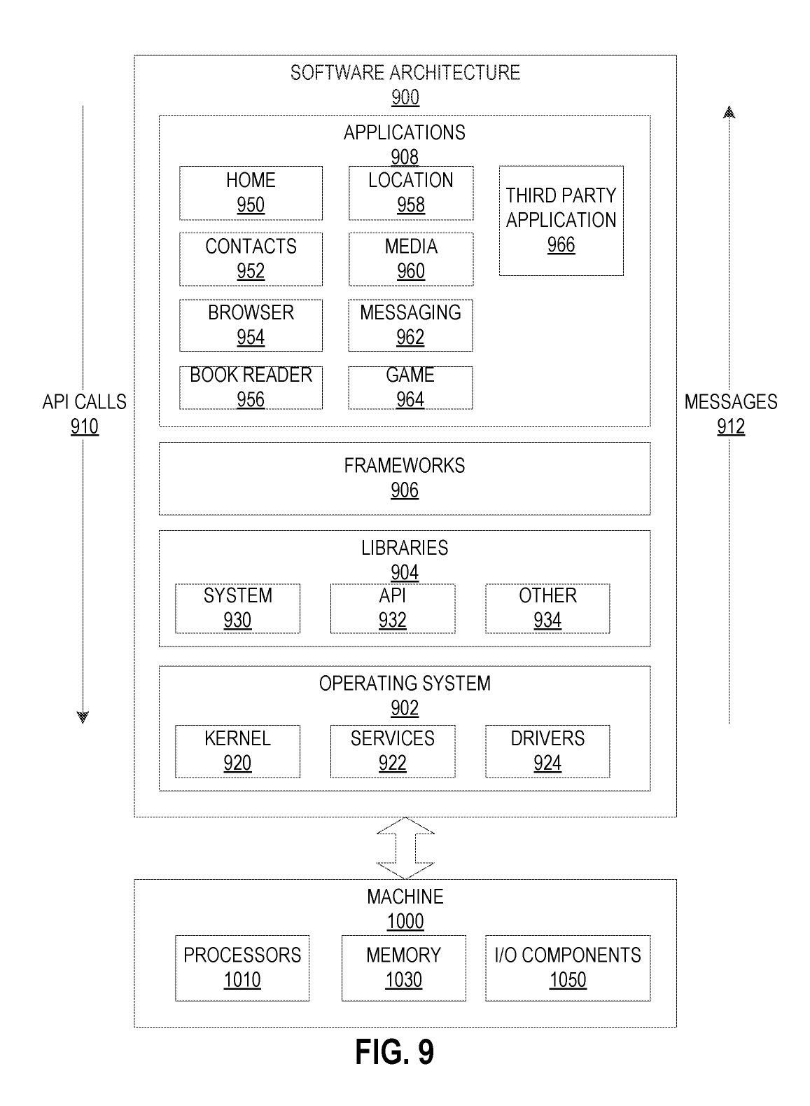

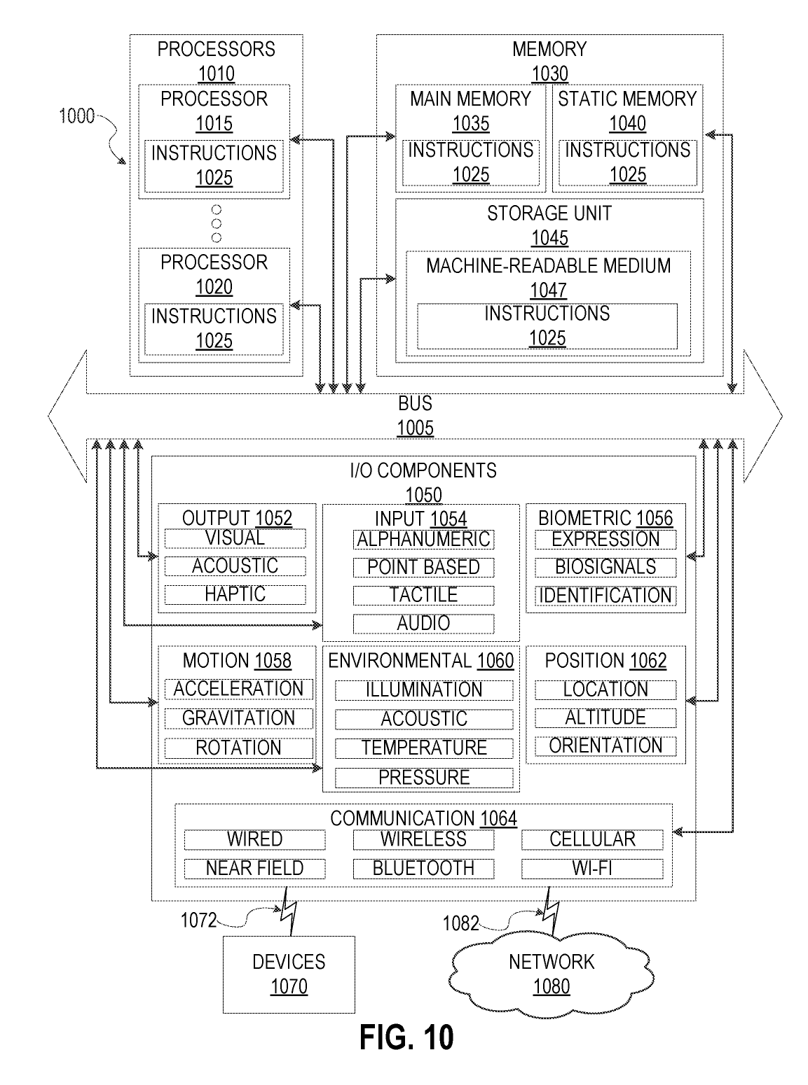

FIG. 9 is a block diagram illustrating an architecture of software 900, which may be installed on any one or more of the devices of FIG. 1. FIG. 9 is merely a non-limiting example of an architecture of software 900 and it will be appreciated that many other architectures may be implemented to facilitate the functionality described herein. The software 900 may be executing on hardware such as a machine 1000 of FIG. 10 that includes processors 1010, memory 1030, and I/O components 1050. In the example architecture of FIG. 9, the software 900 may be conceptualized as a stack of layers where each layer may provide particular functionality. For example, the software 900 may include layers such as an operating system 902, libraries 904, frameworks 906, and applications 908. Operationally, the applications 908 may invoke API calls 910 through the software stack and receive messages 912 in response to the API calls 910.

The operating system 902 may manage hardware resources and provide common services. The operating system 902 may include, for example, a kernel 920, services 922, and drivers 924. The kernel 920 may act as an abstraction layer between the hardware and the other software layers. For example, the kernel 920 may be responsible for memory management, processor management (e.g., scheduling), component management, networking, security settings, and so on. The services 922 may provide other common services for the other software layers. The drivers 924 may be responsible for controlling and/or interfacing with the underlying hardware. For instance, the drivers 924 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 904 may provide a low-level common infrastructure that may be utilized by the applications 908. The libraries 904 may include system libraries 930 (e.g., C standard library) that may provide functions such as memory allocation functions, string manipulation functions, mathematic functions, and the like. In addition, the libraries 904 may include APT libraries 932 such as media libraries (e.g., libraries to support presentation and manipulation of various media formats such as MPEG4, H264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 904 may also include a wide variety of other libraries 934 to provide many other APIs to the applications 908.

The frameworks 906 may provide a high-level common infrastructure that may be utilized by the applications 908. For example, the frameworks 906 may provide various graphical user interface (GUI) functions, high-level resource management, high-level location services, and so forth. The frameworks 906 may provide a broad spectrum of other APIs that may be utilized by the applications 908, some of which may be specific to a particular operating system 902 or platform.

The applications 908 include a home application 950, a contacts application 952, a browser application 954, a book reader application 956, a location application 958, a media application 960, a messaging application 962, a game application 964, and a broad assortment of other applications, such as a third party application 966. In a specific example, the third party application 966 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 966 may invoke the API calls 910 provided by the mobile operating system, such as the operating system 902, to facilitate functionality described herein.

### Example Machine Architecture and Machine-Readable Medium

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1025 (e.g., software 900, a program, an application, an apples, an app, or other executable code) for causing the machine 1000 to perform any one or more of the methodologies discussed herein may be executed. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but be not limited to, a server computer, a client computer, a PC, a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1025, sequentially or otherwise, that specify actions to be taken by the machine 1000. Further, while only a single machine 1000 is illustrated, the term “machine” shall also be taken to include a collection of machines 1000 that individually or jointly execute the instructions 1025 to perform any one or more of the methodologies discussed herein.

The machine 1000 may include processors 1010, memory 1030, and I/O components 1050, which may be configured to communicate with each other via a bus 1005. In an example embodiment, the processors 1010 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 1015 and a processor 1020, which may execute the instructions 1025. The term “processor” is intended to include multi-core processors 1010 that may comprise two or more independent processors 1015, 1020 (also referred to as “cores”) that may execute the instructions 1025 contemporaneously. Although FIG. 10 shows multiple processors 1010, the machine 1000 may include a single processor 1010 with a single core, a single processor 1010 with multiple cores (e.g., a multi-core processor), multiple processors 1010 with a single core, multiple processors 1010 with multiple cores, or any combination thereof.

The memory 1030 may include a main memory 1035, a static memory 1040, and a storage unit 1045 accessible to the processors 1010 via the bus 1005. The storage unit 1045 may include a machine-readable medium 1047 on which are stored the instructions 1025 embodying any one or more of the methodologies or functions described herein. The instructions 1025 may also reside, completely or at least partially, within the main memory 1035, within the static memory 1040, within at least one of the processors 1010 (e.g., within the processor's cache memory), or any suitable combination thereof, during execution thereof by the machine 1000. Accordingly, the main memory 1035, the static memory 1040, and the processors 1010 may be considered machine-readable media 1047.

As used herein, the term “memory” refers to a machine-readable medium 1047 able to store data temporarily or permanently and may be taken to include, but not be limited to, random-access memory (RAM), read-only memory (ROM), buffer memory, flash memory, and cache memory. While the machine-readable medium 1047 is shown, in an example embodiment, to be a single medium, the term “machine-readable medium” should be taken to include a single medium or multiple media (e.g., a centralized or distributed database, or associated caches and servers) able to store the instructions 1025. The term “machine-readable medium” shall also be taken to include any medium, or combination of multiple media, that is capable of storing instructions (e.g., instructions 1025) for execution by a machine (e.g., machine 1000), such that the instructions 1025, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 1050 may include a wide variety of components to receive input, provide and/or produce output, transmit information, exchange information, capture measurements, and so on. It will be appreciated that the I/O components 1050 may include many other components that are not shown in FIG. 10. In various example embodiments, the I/O components 1050 may include output components 1052 and/or input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 1050 may include biometric components 1056, motion components 1058, environmental components 1060, and/or position components 1062, among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 1062 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 and/or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1070 may be another machine 1000 and/or any of a wide variety of peripheral devices (e.g., a peripheral device coupled via a USB).

Moreover, the communication components 1064 may detect identifiers and/or include components operable to detect identifiers. For example, the communication components 1064 may include radio frequency identification (REID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 1080 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (ED(E) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1025 may be transmitted and/or received over the network 1080 using a transmission medium via a network interface device (e.g., a network interface component included in the communication components 1064) and utilizing any one of a number of well-known transfer protocols (e.g., HTTP). Similarly, the instructions 1025 may be transmitted and/or received using a transmission medium via the coupling 1072 (e.g., a peer-to-peer coupling) to the devices 1070. The term “transmission medium” shall be taken to include any intangible medium that is capable of storing, encoding, or carrying the instructions 1025 for execution by the machine 1000, and includes digital or analog communications signals or other intangible media to facilitate communication of such software 900.

Furthermore, the machine-readable medium 1047 is non-transitory (in other words, not having any transitory signals) in that it does not embody a propagating signal. However, labeling the machine-readable medium 1047 as “non-transitory” should not be construed to mean that the medium is incapable of movement; the medium should be considered as being transportable from one physical location to another. Additionally, since the machine-readable medium 1047 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A computer-implemented method performed at a content server system, using at least one computer processor, the method comprising:
accessing a plurality of member records associated with a plurality of members from a database at a content server system, wherein the plurality of member records include member records associated with both active members and inactive members;
analyzing the plurality of member records to identify a list of courses accessed by a plurality of members associated with the plurality of member records;
applying a clustering algorithm to the plurality of member records to group the member records into a plurality of member interest groups based on a lists of courses accessed by members in the member records;
calculating an average retention rate for a particular member interest group based on the retention length of the members in the particular member interest group;
determining whether the average retention rate for the particular member interest group exceeds a predetermined threshold;
in response to a determination that the average retention rate for the particular member interest group exceeds a predetermined threshold:
identifying one or more inactive members within the particular member interest group; wherein an inactive member is a member that has not logged into the content server system within a predetermined time frame;
transmitting a reactivation message to the one or more inactive members within the particular member interest group.

2. The computer implemented method of claim 1, further comprising:
accessing a plurality of course records associated with a plurality of courses from a database, wherein the plurality of courses are grouped into a first group of courses and a second group of courses, the first group of courses associated with a first topic and the second group of courses associated with a second topic;
applying a clustering algorithm to each particular course in either the first group of courses or the second group of courses to create a third group of courses wherein the third group of courses are grouped according to the list of members that have accessed content associated with each particular course and the third group of courses includes at least one course selected from the first group of courses and at least one course selected from the second group of courses;
determining member demand for courses included in the third group of courses; and
in accordance with a determination that the member demand for courses in included in the third group of courses is equal to or greater than a member demand threshold, transmitting a request for additional course content.

3. The method of claim 2, wherein applying a clustering algorithm to each particular course in either the first group of courses or the second group of courses to create a third group of courses further includes:
creating a fourth group of courses wherein the fourth group of courses:
are grouped according to the list of members that have accessed content associated with each particular course;
include at least one course selected from the first group of courses and at least one course selected from the second group of courses; and
there are no courses that were included in the third group of courses.

4. The method of claim 1, further including
detecting a first member accessing an educational content item stored in a second database; and
determining a course associated with an accessed educational content item.

5. The method of claim 4, further including:
accessing a course record associated with the determined course; and
updating the course record to include an identifier of the first member.

6. The method of claim 1, further including:
receiving a course recommendation request associated with a second member;
accessing a member profile for the second member; and
determining the of member interest group associated with the second member based on member profile data in the member profile associated with the second member.

7. The method of claim 6, further comprising:
identifying, based on the member group associated with the second member, one or more courses associated with the member interest group;
ranking each of the one or more identified courses based on a past course access history of the second member;
selecting one or more courses from the one or more identified courses based on the course rankings; and
transmitting the one or more selected courses to the client system for presentation.

8. The method of claim 1, further comprising:
calculating an average retention rate for a plurality of member interest groups;
ranking the plurality of member interest groups;
selecting a member interest group based on the rankings of the member interest group;
transmitting reactivation messages to inactive members within the selected member interest group.

9. The method of claim 1, wherein calculating an average retention rate for a particular member interest group further comprises:
for a particular member in the plurality of members in the particular member interest group:
accessing a subscription initiation date for the particular member
determining whether the subscription associated with the particular member has lapsed;
in response to determining that the subscription associated with the particular member has lapsed, determining a subscription cessation date;
determining a length of subscription for the particular member; and
averaging the length of subscription for a plurality of members in the particular member interest group to determine the average retention rate for the particular member interest group.

10. A system comprising:
a computer-readable memory storing computer-executable instructions that, when executed by one or more hardware processors, configure the system to perform a plurality of operations, the operations comprising:
accessing a plurality of member records associated with a plurality of members from a database at a content server system, wherein the plurality of member records include member records associated with both active members and inactive members;
analyzing the plurality of member records to identify a list of courses accessed by a plurality of members associated with the plurality of member records;
applying a clustering algorithm to the plurality of member records to group the member records into a plurality of member interest groups based on a lists of courses accessed by members in the member records;
calculating an average retention rate for a particular member interest group based on the retention length of the members in the particular member interest group;
determining whether the average retention rate for the particular member interest group exceeds a predetermined threshold;
in response to a determination that the average retention rate for the particular member interest group exceeds a predetermined threshold:
identifying one or more inactive members within the particular member interest group; wherein an inactive member is a member that has not logged into the content server system within a predetermined time frame;
transmitting a reactivation message to the one or more inactive members within the particular member interest group.

11. The system of claim 10, further comprising instructions for:
accessing a plurality of course records associated with a plurality of courses from a database, wherein the plurality of courses are grouped into a first group of courses and a second group of courses, the first group of courses associated with a first topic and the second group of courses associated with a second topic;
applying a clustering algorithm to each particular course in either the first group of courses or the second group of courses to create a third group of courses wherein the third group of courses are grouped according to the list of members that have accessed content associated with each particular course and the third group of courses includes at least one course selected from the first group of courses and at least one course selected from the second group of courses;
determining member demand for courses included in the third group of courses; and
in accordance with a determination that the member demand for courses in included in the third group of courses is equal to or greater than a member demand threshold, transmitting a request for additional course content.

12. The system of claim 11, wherein applying a clustering algorithm to each particular course in either the first group of courses or the second group of courses to create a third group of courses further includes:
creating a fourth group of courses wherein the fourth group of courses:
are grouped according to the list of members that have accessed content associated with each particular course;
include at least one course selected from the first group of courses and at least one course selected from the second group of courses; and
there are no courses that were included in the third group of courses.

13. The system of claim 10, further comprising instructions for:
detecting a first member accessing an educational content item stored in a second database; and
determining a course associated with an accessed educational content item.

14. The system of claim 13, further comprising instructions for:
accessing a course record associated with the determined course; and
updating the course record to include an identifier of the first member.

15. The system of claim 10, further comprising instructions for:
receiving a course recommendation request associated with a second member;
accessing a member profile for the second member; and
determining the of member interest group associated with the second member based on member profile data in the member profile associated with the second member.

16. The system of claim 15, further comprising instructions for:
identifying, based on the member group associated with the second member, one or more courses associated with the member interest group;
ranking each of the one or more identified courses based on a past course access history of the second member;
selecting one or more courses from the one or more identified courses based on the course rankings; and
transmitting the one or more selected courses to the client system for presentation.

16. A non-transitory computer-readable storage medium storing instructions that, when executed by the one or more processors of a machine, cause the machine to perform operations comprising:
accessing a plurality of member records associated with a plurality of members from a database at a content server system, wherein the plurality of member records include member records associated with both active members and inactive members;
analyzing the plurality of member records to identify a list of courses accessed by a plurality of members associated with the plurality of member records;
applying a clustering algorithm to the plurality of member records to group the member records into a plurality of member interest groups based on a lists of courses accessed by members in the member records;
calculating an average retention rate for a particular member interest group based on the retention length of the members in the particular member interest group;
determining whether the average retention rate for the particular member interest group exceeds a predetermined threshold;
in response to a determination that the average retention rate for the particular member interest group exceeds a predetermined threshold:
identifying one or more inactive members within the particular member interest group; wherein an inactive member is a member that has not logged into the content server system within a predetermined time frame;
transmitting a reactivation message to the one or more inactive members within the particular member interest group.

17. The non-transitory computer-readable storage medium of claim 16, further comprising instructions for:
accessing a plurality of course records associated with a plurality of courses from a database, wherein the plurality of courses are grouped into a first group of courses and a second group of courses, the first group of courses associated with a first topic and the second group of courses associated with a second topic;
applying a clustering algorithm to each particular course in either the first group of courses or the second group of courses to create a third group of courses wherein the third group of courses are grouped according to the list of members that have accessed content associated with each particular course and the third group of courses includes at least one course selected from the first group of courses and at least one course selected from the second group of courses;
determining member demand for courses included in the third group of courses; and
in accordance with a determination that the member demand for courses in included in the third group of courses is equal to or greater than a member demand threshold, transmitting a request for additional course content.

18. The non-transitory computer-readable storage medium of claim 17, wherein applying a clustering algorithm to each particular course in either the first group of courses or the second group of courses to create a third group of courses further includes:
creating a fourth group of courses wherein the fourth group of courses:
are grouped according to the list of members that have accessed content associated with each particular course;
include at least one course selected from the first group of courses and at least one course selected from the second group of courses; and
there are no courses that were included in the third group of courses.

19. The non-transitory computer-readable storage medium of claim 17, further comprising instructions for:
detecting a first member accessing an educational content item stored in a second database; and
determining a course associated with an accessed educational content item.

20. The non-transitory computer-readable storage medium of claim 19, further comprising instructions for:
accessing a course record associated with the determined course; and
updating the course record to include an identifier of the first member.
